(19) United States
(12) Patent Application Publication
(10) Pub. No.: US 2002/0165957 A1
(43) Pub. Date: Nov. 7, 2002

(54) Intelligent dynamic route selection based on active probing of network operational characteristics

(76) Inventors: Jiva Gandhara Devoe, Tempe, AZ (US); Jay D. Jacobson, Phoenix, AZ (US); Nicholas Michael Estes, Tempe, AZ (US)

Correspondence Address: HICKMAN PALERMO TRUONG & BECKER, LLP, 1600 WILLOW STREET, SAN JOSE, CA, 95125, US

(21) Appl. No.: 09/970,398

(22) Filed: Oct. 2, 2001

Related U.S. Application Data
(60) Provisional application No. 60/288,398, filed on May 2, 2001.

(51) Int. Cl. G06F 15/173

(52) U.S. Cl. 709/224; 709/242

(57) ABSTRACT

A method for building a network route map is described in which network operational characteristics are gathered by actively probing multiple network routes, and building the network route map based on the operational characteristics. Route maps are generated which provide a view of the network from the perspective of a particular routing device in the network. Embodiments include methods for gathering the operational data by transmitting one or more data packets, receiving responses thereto, and determining time differentials based on the responses. Other embodiments include methods for processing the operational data to determine various metrics, and normalizing the data with similar data gathered from other network route probes. Finally, additional embodiments include propagation of the preferred route information to multiple routing devices to provide intelligent route selection thereto.

### CROSS REFERENCE TO RELATED APPLICATION

This patent application claims priority from U.S. Provisional Patent Application No. 60/288,398, entitled “Inter-Domain Dynamic Route Selection For Diversified IPV4 Networks”, filed by Jiva Gandhara DeVoe, Jay D. Jacobson, and Nicolas Michael Estes on May 2, 2001, the contents of which are herein incorporated by reference in its entirety.

### FIELD OF THE INVENTION

The present invention relates generally to communication over a network; more specifically, to techniques for intelligently and dynamically selecting network routes based on operational characteristics obtained by actively probing the network.

### BACKGROUND OF THE INVENTION

The global Internet's progenitor was the Advanced Research Projects Agency Network (ARPANet), which was originally designed for high network reliability and resilience, not necessarily for efficient routing of data. The current Internet consists of a multitude of diverse networks and hence, information about routing is decentralized. Individual networks are aware of their own and neighboring networks, but do not typically have detailed information for all networks comprising the Internet, partly due to the volatility of routing information. Hence, optimal routing of data packets through the Internet and related networks has never been achieved.

Layer 3 is the network layer of the multi-layered OSI (Open Systems Interconnection) communication model. The Network layer is concerned with knowing the address of the neighboring nodes in the network, selecting routes and quality of service, and recognizing and forwarding to the Transport layer (layer 4) incoming messages for local host domains. A router is a layer 3 device, although some switches also perform layer 3 functions. Furthermore, an Internet Protocol (IP) address is considered a layer 3 address.

When a router receives a packet, it makes a routing decision (at times referred to as a packet-forwarding decision) based on the destination address portion of the packet. It then looks up the destination address in its routing table, which is a list of networks, and thus routes, that the router knows about. If the destination address is within a known network the router forwards the packet to the next hop gateway for that destination network. Once the packet leaves the router, it is the responsibility of the next hop gateway to forward the packet to its final destination. If the router does not have the destination network in its routing table, it may forward the packet to a predetermined default gateway and let the default gateway handle getting the packet to the destination network, or it will drop the packet.

In networks with only a single route to the Internet, routers currently make static layer 3 routing decisions. Using static layer 3 routing decisions, a router is limited to a routing table look-up offering one choice for each routing decision, which relies primarily on network topology and static network traffic characteristics. Due to the dynamic nature of network operational and performance characteristics, these routing decisions are inflexible and are likely sub-optimal at various points in time. In addition, static routing implementations have no capability to dynamically address specific performance metrics of their network and the Internet as a whole. In networks with multiple routes to the Internet, routers typically make static and dynamic layer 3 routing decisions in order to choose between the available alternate routes. When a router makes a dynamic routing decision, the router relies on awareness of external network conditions affecting reachability of a destination, and is able to react to these reachability-centric conditions. Generally, reachability describes whether or not the one-way “forward” path to a network neighbor is functioning properly. More specifically, whether packets sent to a neighbor are reaching the IP layer on the neighboring machine and are being processed properly by the receiving IP layer. Routes that have failures or that are otherwise unavailable can be avoided, thus providing more reliable routing of data.

Currently, dynamic layer-3 routing decisions are typically made based upon the number of Autonomous System (AS) hops in a given source-to-destination route. An AS can be defined as a set of routers under a single technical administration, using one or more interior gateway protocols and common metrics to route packets within the AS, and using an exterior gateway protocol to route packets to other ASs. The administration of an AS appears to other ASs to have a single coherent interior routing plan and presents a consistent picture of what destinations are reachable through it. An AS hop is defined as a transition from one AS to another.

Although there are a tremendous number of factors to consider when choosing a packet forwarding path on a network, conventional routing protocols typically consider only a small number of these factors. For example, making dynamic layer 3 routing decisions based on AS hops is accomplished through use of the exterior Border Gateway Protocol (BGP), and its cooperatively propagated decentralized route information base (RIB). The RIB consists of passively gathered information about connected networks, or peers. The assumption made by BGP is that for any given path, the route with the least number of AS hops is preferable. Using BGP, network routes used by a routing device are originated by injecting routing information into BGP, and are advertised to its BGP peers, so that the routes may be propagated to peer network routing devices. Version 4 of BGP (BGP-4) is specified in RFC 1771 of the Network Working Group of the IETF (Internet Engineering Task Force).

In addition to the dynamic information from the RIB, BGP allows network administrators to define static path preferences. Utilizing the static preferences and the dynamic information from the RIB, an individual layer-3 router is able to build a table of routes to describe how it will make its routing decisions. The table is populated with routes determined to be the preferred routes based on the information and the preferences. The preferred routes from a BGP-compatible router's RIB are propagated through peering sessions with other routers. A receiving router processes these updates, reevaluates its RIB, and re-propagates the updates to its other BGP peers, thus informing them of its preferred routes and network reachability.

In this context, the term “operational characteristics” is generally used to describe characteristics of a network which affect the functioning, or operational performance, of the network. In other words, any state of any entity constituent to a network, whether physical hardware and/or programming code, that has an affect, either independently or in conjunction with another, on how any portion of the network functions, could be considered an operational characteristic of the network. Unfortunately, BGP has no capacity for discovering and sharing network performance or operational characteristics, and BGP-enabled routers rely on AS hops to make dynamic packet forwarding decisions. Consequently, network operational metrics are not considered in its preferred route determinations. Furthermore, the BGP approach does not offer the ability to actively discover operational characteristics, and thus its ability to make routing decisions is limited and sub-optimal. A complete, cohesive view of global network conditions, characteristics, and configurations is not readily obtainable from the perspective of any single network in the system. Past practices for providing routing intelligence typically involve manual measurements of limited information and manual reconfiguring of network devices, which is slow and labor-intensive, and not readily adaptable to constantly changing network characteristics. Some approaches are less manual than the previous example, but are likewise disadvantaged by their limited scope and vision of the network.

For example, referencing the example network of FIG. 1, suppose a device 102 transmits a series of packets addressed to the device 108. Utilizing a BGP-enabled system of dynamic routing, a series of routers from device 102 to device 108 may decide that the packet should take the path with the fewest AS hops, which would be from the first AS 110 to the second AS 112, for example, a path including the following entities: Device 102-R12R22-Backbone 1-R31-R42-R51-Device 108.

In the near past, much of the focus on routing technology has been on the “first mile,” which describes the portion of a network that connects the content provider with the core infrastructure of the Internet, and the “last mile,” the portion of a network that connects the core infrastructure of the Internet with the end-user. The result is that the “middle mile,” which constitutes the bulk of the Internet's core infrastructure, accounts for a large portion of the total packet transmission time. The middle mile lag problem is exacerbated by the use of more media-rich content, such as content with voice, video, high-resolution graphics, and enhanced audio. A common problem facing content providers and users is Internet performance, which is often limited by network routing bottlenecks and outages.

Based on the foregoing shortcomings, a previously unmet need is recognized for a solution to enhancing network performance through routing intelligence. A more specific previously unmet need exists for an approach to providing routers with sufficient and timely network awareness in order for them to route data based on optimized network routing decisions.

### SUMMARY OF THE INVENTION

Aspects of the invention apply to route information intelligence with relation to computer networks. More specifically, aspects overcome limitations in the art in relation to when a network routing device receives data and must switch, route, or forward the data to another interface, device, medium, network, application, protocol, or otherwise.

In one aspect, a method for building a network route map is described in which network operational characteristics are gathered by actively probing multiple network routes, and building the network route map based on the operational characteristics. Embodiments include methods for determining metrics based on the operational characteristics, for non-limiting examples, packet loss, latency, and number of hops. Furthermore, embodiments include methods of determining the metrics by transmitting a data packet with a time to live value to a high port number, receiving responses thereto, and determining time differentials based on the responses. Additional metrics that can be determined based on the gathered operational characteristics include, but are not limited to, network access point congestion, circuit congestion, throughput, historical reliability, maximum circuit capacity, and transmission protocol characteristics.

The network operational data obtained through active probing of network routes can be normalized with similar data gathered from other network route probes. In addition, the normalized metrics can be weighted and combined with other metrics to arrive at a score, which can be used to compare multiple network routes from different perspectives. One embodiment includes propagation of network routes, determined based on the network route map, to multiple routing devices to provide relatively current network operational information for dynamically selecting optimized network routes.

In one aspect, a probe device is configured to actively gather operational characteristic data related to multiple network routes connected to a routing device. The probe device is communicatively connected to a route optimization engine and is configured to build the network route map from particular perspectives based on the data received from one or more probe devices. The route map provides routing intelligence for selecting preferred routes for network traffic through the routing device. Embodiments include a translator for converting the optimized route information into a format according to a standard protocol, and a server for propagating the translated route information to other network routing devices. In one embodiment, the server is a Border Gateway Protocol (BGP) server and the information is propagated via conventional BGP peering sessions.

Implementations include configuring the probe or probes on a single machine with the route optimization engine, and configuring the probe or probes on a separate machine than the route optimization engine. In the latter implementation, the probe device and optimization engine can communicate over a network.

The active probing is performed continuously such that an extensive database of network operational data is constructed. Numerous measured data obtained from the active probing from numerous sources with different perspectives of the network is dissected, normalized, weighted, and combined into a cohesive collective, thus reducing the impact of abnormal operational characteristics specific to any one perspective. Customized maps of optimized routes for many network devices, specific to the perspective and configuration of the devices and their surrounding network, can be built and shared. Hence, next-hop gateways can be configured appropriately.

Implementations are embodied in methods, systems, apparatus, and in a computer-readable medium.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram illustrating an example of a simplified network on which the invention may be implemented;

FIG. 2 is a block diagram illustrating a system for building network route maps, according to an embodiment of the invention;

FIG. 3 is a flow diagram depicting a method for building a network map, according to an aspect of the invention;

FIG. 4 is a flow diagram depicting a method for routing information on a network, according to an aspect of the invention;

FIG. 5 is a flow diagram depicting a method for routing information on a network, according to an aspect of the invention; and

FIG. 6 is a block diagram illustrating a computer system upon which an embodiment of the invention may be implemented.

### DETAILED DESCRIPTION

A method and system for dynamically building network route maps based on network operational characteristics is described. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Functional Overview

Techniques for building a network route map are described, wherein operational characteristics of the network of interest are actively probed and whereby the network route map is built based on the gathered data representing the operational characteristics. Hence, an optimized, or preferred, transmission route between two host addresses, or network nodes, can be intelligently and dynamically determined based on a relatively current understanding of how alternate routes are operating or performing.

An advantage of this technique is the ability to gather information related to network performance in addition to network reachability. In addition, the present technique is able to gather information at the low level of a network hop, as opposed to the high level of Autonomous Systems. Still further, the present technique actively gathers information about the network, as opposed to passively waiting to receive advertised information based on the knowledge of a peer.

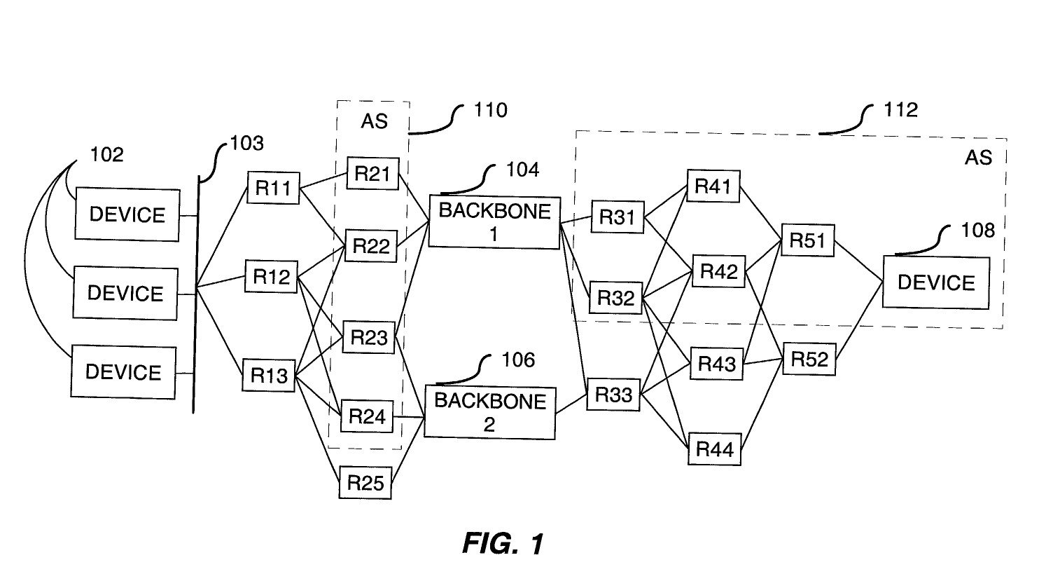

FIG. 1 is a block diagram illustrating an example of a simplified network on which the invention may be implemented. FIG. 1 depicts a plurality of devices 102, such as a computer or other Internet appliance, connected to a LAN 103 (Local Area Network). The LAN 103, employing conventional technology such as Ethernet, is depicted with a plurality of connections to a network of routing devices (depicted as R11 through R52) such as routers, transmission backbones 104 and 106, and other devices such as device 108. The transmission backbones 104 and 106 depict a high-bandwidth, long-distance transmission line that interconnects multiple local or regional network lines. Device 108 could be a computer, an Internet appliance, or another network-enabled device. A network on which embodiments of the invention can be implemented could be any type of network employing a plurality of transmission routes from one device to another, for example, an enterprise network, or a WAN (Wide Area Network) such as the Internet, and any type of associated communication protocols which function similarly to TCP/IP. For illustrative purposes, embodiments of the invention will be described herein in reference to an implementation on the Internet, utilizing TCP/IP communication protocols, but the practice of the invention is not limited to use in such a context. FIG. 1 further depicts a first Autonomous System (AS) 110 and a second AS 112 (depicted as hashed blocks).

As presented above, utilizing a BGP-enabled system of dynamic routing, a series of routers from device 102 to device 108 may decide that the packet should take the path with the fewest AS hops, which would be from the first AS 110 to the second AS 112, for example, a path including the following entities: Device 102-Rl2-R22-Backbone 1-R31-R42-R51-Device 108.

In contrast, a system configured according to an embodiment of the invention bases its packet routing/forwarding decisions on information that it has knowledge of with respect to the network performance. Consideration of network performance information can lead to significantly different and better routing decisions. For example, assume that the path selected by the BGP-enabled system consists of one or more non-functional or marginally functional components, for example, a cut line, a damaged router, a series of routers with historic unreliability, or an overly congested network access point. These types of problems may be exhibited through a number of operational characteristics, or metrics, that are gathered through actively probing network routes through implementation of embodiments of the invention. For example, network performance degradation along a particular network route may be exhibited through discernible metrics obtained from measurable characteristics, such as dropped or lost data packets, latency, throughput, number of layer 3 hops, circuit capacity, circuit congestion, network access point (NAP) congestion, historical reliability, path reachability, varying transmission protocol characteristics, and more. As a result, a routing device configured according to an embodiment of the present invention would likely select a different network route, i.e., a different packet forwarding path, to travel from device 102 to device 108 more optimally, and hence faster and more reliably, than would the BGP-enabled system. For example, it may choose the following path, Device 102-R13-R25-Backbone 2-R33-R43-R52-Device 108, which completely avoids AS 110 and AS 112 due to any number of network problems. Alternatively, it may choose a path that does travel through AS 110 or AS 112, if it is determined that their constituent routers and lines are performing optimally.

### System for Building Network Route Maps

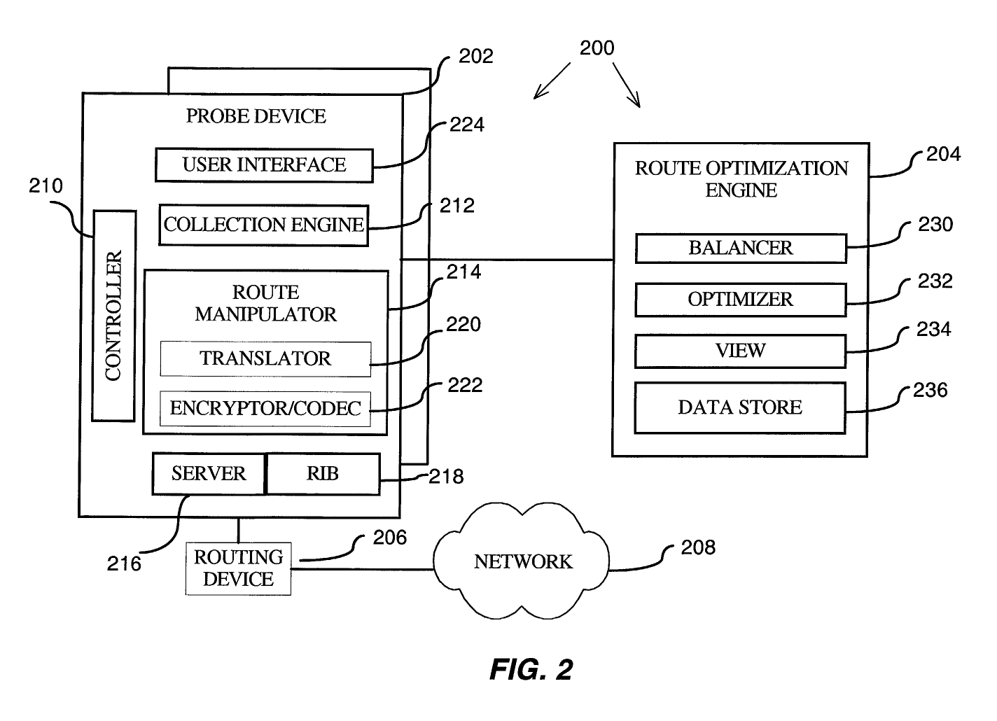

FIG. 2 is a block diagram illustrating a system 200 for building network route maps, according to an embodiment of the invention. The system 200 could be implemented in multiple ways, for example, as a stand-alone software program, as a combination of software and hardware, or as hardware running embedded firmware. The system 200 comprises one or more probe devices 202 communicatively connected to a route optimization engine 204. Furthermore, each probe device 202 is communicatively connected to one or more routing devices 206, such as a conventional router, which is in turn connected to, or part of, a network 208, such as the Internet. To correlate to example network of FIG. 1, the routing device 206 could be any of the routing devices (depicted as R11 through R52), and the network 208 could be the network of FIG. 1 between and including the routing devices.

Probe devices 202 are not necessarily associated with a single routing device 206, but may be implemented to actively probe network routes associated with more than one routing device 206. In addition, a probe device 202 is operable with any conventional routing device 206 that employs BGP, either directly or in conjunction with a gateway, for exchanging routing information. It is also noteworthy that the operations of networks deploying probe devices 202 are not dependent on the probe devices 202 for routing information. That is, a probe device 202 is not a point of failure for any portion of any network. Upon a failure of a probe device 202, the associated network routing device 206 can revert to conventional BGP-propagated routing information in making its routing decisions.

Several physical configurations can be implemented within the scope of the invention. For example, organizations that own and maintain networks containing routing devices 206 can have a probe device 202 communicatively connected to each of their routing devices 206, or to a strategic subset of their routing devices 206. In one embodiment, the probe device 202 can be installed external to the network routes coupled to the routing devices 206, and thus, external to the network data stream. Hence, no network down-time is experienced upon a failure of a probe device 202 and no network performance degradation is experienced due intrinsically to the physical installation of the probe device 202.

In one embodiment, all probe devices 202 deployed on the Internet communicate with and rely on a single route optimization engine 204 located at a single location, such as a data center or warehouse. Note that in a configuration in which a single route optimization engine 204 is deployed, there may be multiple instances of the optimization engine 204 for redundancy and fail-over purposes, but essentially only one optimization engine is performing at a time. In addition, the multiple instances of the optimization engine 204 may reside at multiple physical locations for security and reliability purposes, to protect from catastrophic failures at a single location. Furthermore, the optimization engine 204 may be controlled and maintained by a single organization (e.g., a routing service provider) serving the needs of the entire Internet, or a plurality of network infrastructure providers may each control and maintain one or more communicatively connected optimization engines 204 associated with their probe devices 202 and routing devices 206.

In another embodiment, multiple optimization engines 204 may be spread around the world at central locations. In this embodiment, the optimization engines are configured to process certain sectors of the Internet and to communicate with each other to share information and to balance processing loads when necessary. The distributed optimization engines 204 may transmit all of the network operational data from their associated probe devices 202 to a central database, or they may store their data distributed around the world, central to the Internet sector for which each is responsible. Probe devices 202 and optimization engines 204 may operate on the same computing platform or machine, or they may operate on separate computing platforms or machines. If configured on separate machines, the probe devices 202 and optimization engines 204 can communicate through a network, such as a LAN or a WAN (e.g., the Internet) or any other suitable communication method, including wireless communication. Ultimately, any physical implementation or configuration of probe devices 202 and route optimization engine(s) 204 is within the scope of the present invention.

The probe device 202 includes a controller 210, a collection engine 212, a route manipulator 214, a server 216 with a route information base (RIB) 218, and a user interface 224. The controller 210 controls the operation of the system 200. For example, the controller 210 requests a dataset, which in one embodiment is encrypted and compressed, from the route optimization engine 204. The dataset contains a list of network IP addresses that the optimization engine 204 has determined need to be actively probed for operational data by the particular probe device 202 housing the controller 210. The list is subsequently provided to the collection engine 212, for example, via function calls, which executes logic to perform the active probing of network routes for operational characteristics. For another example, the controller 210 requests an optimized route map specific to the routing device 206, and thus specific to the network location of the probe device 202, from the route optimization engine 204.

Active probing of network routes occurs across multiple network routes communicatively connected to the particular routing device 206 associated with a particular probe device 202. Active probing may occur in parallel across all available peers, from as many network perspectives as possible. Furthermore, due to the volatile nature of Internet operational characteristics, collecting data and computing metrics thereon is preferably a continuous and ongoing process, although the invention is not limited to any particular frequency of data collection.

In one embodiment, active probes generated by the collection engine 212 of probe device 202 consist of a series of one-byte payload packets generated to the first available IP (or other, if not using IP protocol) address on each known network route. Probes use random high port numbers with increasing TTL (time to live) values, similar to the common network diagnostic tool traceroute. The TTL value is designed to be exceeded by the first router that receives it, which will return a ICMP_TTL_EXPIRED or similar message indicating that the TTL is expired (Time Exceeded message), thus providing the time to hop to the first router. Increasing the time limit value, the packet is sent from the first router so that it will reach the second router in the path to the destination, which returns another Time Exceeded message, and so forth. In addition, this method determines when the packet has reached the destination by including a port number that is outside the normal range. When the packet is received at the destination, a ICMP_PORT_UNREACH or similar message indicating that the port is unreachable (Port Unreachable message) is returned, indicating that the destination machine is not listening on the port to which the packet was sent. This enables the method to measure the time length of the final hop. Herein, a hop is defined as the trip a data packet takes from one routing device or intermediate point to another in the network.

Responses to the probe packets are received at the collection engine 212 and are measured to determine the time between sending the probe packet and receiving the response packet. This time delta is used for, among other things, judging latency between each hop in the probed network route. Latency can be introduced into a transmission due to varying network conditions, for example, limitations on communication media, the speed of light, optical/electrical conversions, or protocol conversions. Using the time delta described above is but one example of determining a metric for network latency, for latency can be derived based on other operational characteristics. Thus, the invention is not limited to such a method of determining a latency metric.

In addition, each responding routing device stamps probe packets with its own IP address, which is used to determine the routing device's associated AS by comparison with data obtained from a peer propagation session, for example, a BGP propagation session. The IP addresses of routing devices along the probed route are also compared to a database of known NAPs (Network Access Point), which are major Internet interconnections or physical data exchange points that serve to tie all the Internet access providers together, to determine whether the probe packet has traveled through a NAP. NAPs can be problematic for data transit due to different possible circumstances, for example, legacy architecture, limited corporate or political cooperation, or overloaded capacity.

As the probe packet proceeds to its destination, packet loss can be measured from probes sent that do not result in corresponding acknowledgements. This information is also used for determining route reliability and circuit congestion, as circuit congestion is often exhibited as packet loss. In this sense, circuit congestion refers to an interval of time in which data transiting a network link, when combined with efficiency limitations and protocol/architecture overhead on that link, experiences negative performance characteristics even if the theoretical maximum circuit capacity has not been reached. The theoretical maximum circuit capacity is the maximum amount of data that can be continually sent across a particular link. Using packet loss as described above is an example of determining a metric for network route reliability and circuit congestion, for metrics can be derived based on other operational characteristics. Thus, the invention is not limited to such a method of determining a metric to describe route reliability and circuit congestion of a network or a portion thereof.

The foregoing technique for active probing is an embodiment of the invention. Other means of actively probing network routes may be implemented and still fall within the scope of the invention. In general, active probing of network operational characteristics should be actively initiated to discover information about a network of interest, as opposed to passively relying on reception of information from another entity. Furthermore, operational, or performance-related characteristics are significantly valuable in building routing tables and selecting route paths to forward data packets through the network optimally, or at least with improved routing performance, resulting from enhanced visibility of the surrounding network performance.

Generally, the route manipulator 214 serves as the interface and translation layer between the server 216 and the rest of probe device 202. The route manipulator 214 comprises a translator 220, and an encryptor/codec 222. In one embodiment, the translator 220 functions to translate network route maps built by the route optimization engine 204 and passed to the probe device 202, from one format to another format. For example, the route map information may arrive at the probe device 202 in a proprietary format, whereby the translator 220 translates, or converts, the route map information into a more commonly used open source or standard protocol format, such as BGP-4. Translation facilitates sharing the route maps with peer routing devices, wherein a peer routing device is configured with the IP addresses and AS numbers of its peers.

In one embodiment which utilizes a network to communicate between the probe device 202 and the route optimization engine 204, the encryptor/codec 222 operates to encrypt and compress the data representing network operational characteristics that were gathered through the active probing of the probe device 202, prior to passing to the route optimization engine 204. Furthermore, the encryptor/codec 222 operates to decrypt and decompress the dataset of IP addresses, specifying probe routes, which are sent from the optimization engine 204 to the probe device 202. Still further, upon reception of a route map from the optimization engine 204 at the probe device 202, the encryptor/codec 222 operates to decompress and decrypt the route map prior to passing to the translator 220. If both the probe device 202 and the optimization engine 204 are implemented on the same machine and thus do not communicate over an unsecured network, then the encryptor/codec 222 is not necessarily needed.

The interface capabilities of the route manipulator 214 include providing access to the server 216 for administrative tasks, establishing communication with the server 216, and any protocol conversion that may be necessary to communicate with the server 216.

In one embodiment, the server 216 is a BGP server for establishing peering sessions with BGP-enabled layer 3 routing devices on the same logical layer 2 network segment. Each routing device 206 that is peered with a probe device 202 will propagate to other peer routing devices preferred network routes based on the route map information received by the probe device 202 from the optimization engine 204. According to one embodiment, using BGP, network routes used by a routing device are originated by injecting routing information into BGP, and are advertised to its BGP peers, so that the routes may be propagated to peer network routing devices. The propagation process involves the route manipulator 214 setting the preferred route information in the RIB 218 of server 216. Thus, using the peering relationships already established between the server 216 and the routing device 206, the optimized routes are propagated to the other peer routing devices, where they are received and inserted into corresponding BGP RIBs. In addition, the server 216 operates to pass the information from the probe device 202 to the route optimization engine 204, such as the encrypted and compressed operational data obtained through active probing of network routes by the probe device 202.

Once a certain portion of the network routes are actively probed for operational characteristics by the collection engine 212, the data is encrypted and compressed by the encryptor/codec 222 and passed to the route optimization engine 204 (if communicating over a network), as described above.

The route optimization engine comprises a balancer 230, an optimizer 232, a view 234, and a data store 236.

The balancer 230 of optimization engine 204 serves as an interface with the probe device 202. As such, the balancer serves as a queue for the raw data representing the network operational characteristics that are obtained by and received from the probe device 202, thus balancing the load between the probe device 202 and the optimizer 232. The balancer 230 can also access the data store 236 for configuration information related to the probe device 202 and the optimization engine 204, in order to authenticate the probe device 202. In one implementation, the balancer 230 is a computer system with which the probe device 202 communicates to transmit and receive information, and serves as an interface between the probe device 202 and the rest of the route optimization engine 204.

The balancer 230 can be further configured with an encryptor/codec 238. If an embodiment in which the probe device 202 and the route optimization engine 204 communicate over a network, the route maps are encrypted and compressed by the encryptor/codec 238 and sent to the corresponding probe device 202. The encryptor/codec 238 also operates to encrypt and compress any other communications to the probe devices 202, as well as to decrypt and decompress communications received from the probe devices 202. The description of the encryption/decryption and compression/decompression of data communications between probe devices 202 and the route optimization engine 204 is not intended to limit the invention as such, but is presented as an implementation only. Furthermore, in such an implementation, the encryption logic and the compression logic are not necessarily configured together as indicated by the designation “encryptor/codec.”

The optimizer 232 of optimization engine 204 is the primary processing unit for manipulating and analyzing the network operational data, which was obtained through active probing of the network by, and received from, the probe device 202. The operational data is stored in data store 236. The optimization engine 204 combines data gathered by multiple probe devices 202 to form a complete known view of the numerous Internet operational characteristics measured. The optimization engine 204 dissects data from each probe device 202 into its smallest components, for example, down to the individual hop level, and merges it into a global collection of data from all probe devices 202. The data is manipulated into metrics from numerous network perspectives associated with numerous routing devices 206. Furthermore, operational data related to any one routing device is obtained through probing the network from multiple perspectives. For example, a particular routing device may be the originating router for some probes, it may be the destination router for other probes, and it may be a transit router for still other probes. Hence, the information gathered with respect to a particular routing device, and the metric derived therefrom, is a consolidation of data from different network perspectives. This reduces the impact of abnormal performance characteristics specific to any one perspective.

In one embodiment, a user can specify a telecommunication carrier preference, which can be integrated with the operational characteristics when building a route map for a particular routing device. For example, different carriers may provide network bandwidth or other services at different costs than other carriers, thus a user can configure the system 200 to apply more weight to a low-cost carrier than to a high-cost carrier. Thus, when a route map is built for a routing device based on the operational characteristics and the carrier preferences associated with that routing device, with all other metrics being equal, a route utilizing a preferred carrier will be considered a preferred route.

Operational data is combined into a global collection and is stored in the data store 236, which may be a local data store logically within the optimization engine 204 or an external database communicatively connected to the optimization engine 204. In one embodiment, as the data is being processed for merging with the global data, it is normalized, thus providing a normalized value for every known route. Consequently, metrics within a metric type can be compared simply and accurately. The normalized value for each metric for each route is then multiplied by a weighting value, summed, and subtracted from 100 to produce a score. For example:

100−[(packet loss*40%)+(latency*30%)+(layer−3 hops*16%)+(NAP hops*10%)+(AS hops*4%)]=score.

Each known route receives a score according to this general calculation. The multiplication factors and the metrics used to compute a score, as presented above, are examples only and do not limit practice of the invention to those presented. In one embodiment, these factors can be specified by a user.

Utilizing the scores for each actively probed route, the optimizer 232 can generate optimized routes, from any perspective or point on the network, which can be sent to the view 234. The view 234 is operable to efficiently store the optimized routes generated by the optimizer 232, and to produce a performance-optimized route map, or view, of the network from a single perspective. Furthermore, the view 234, through use of optimized data structures, operates such that it can rapidly provide a requested view. For example, a dataset comprising sixty million data points can produce a requested view on the order of two to three seconds. The route map essentially comprises descriptions of network routes from a routing device 206 to multiple destinations reachable from that routing device. In one embodiment, the optimizer 232 is also capable of executing an algorithm for computing the reliability of the routes that it is processing.

In one embodiment, when the probe device 202 is ready to receive its route map, it makes a request to the route optimization engine 204. Alternatively, the optimization engine 204 can periodically push route maps to corresponding probe devices 202. Upon reception of the request, the view 234 builds a customized route map of optimized routes specific to the perspective and configuration of the requesting network. If communicating over a network, the route map is encrypted and compressed by the encryptor/codec 236 and sent to the corresponding probe device 202.

Upon reception of the route map, the probe device 202 creates new routes in the RIB 218 and configuring its next-hop gateway according to the new routes. Again, according to one embodiment, through a conventional BGP peering session with affiliated routing devices, the routes derived from the route map are propagated to the routing devices. Mechanisms other than BGP may be employed to propagate network routing information to routing devices within the network, and fall within the scope of the invention. Routing devices can be configured to set a local preference for routes received from the probe device 202 so that the routing device will prefer use of the optimized routes over routes received from other peering mechanisms.

### Method for Building Network Route Maps

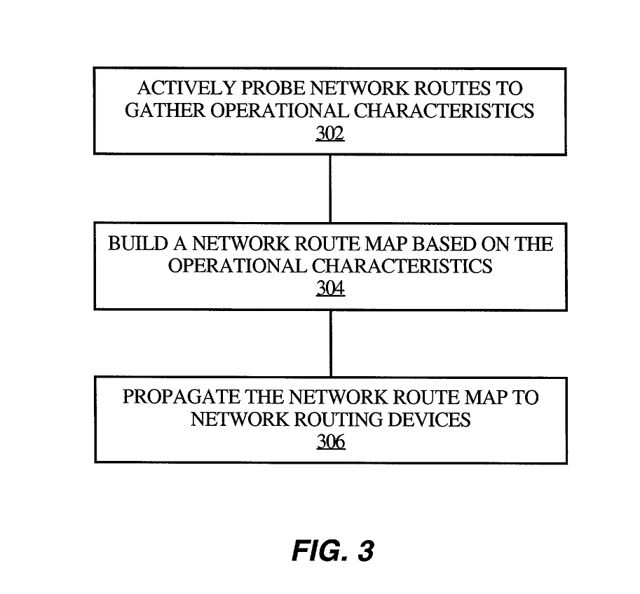

FIG. 3 is a flow diagram depicting a method for building a network map. At step 302, network routes are actively probed to gather network operational characteristics. For example, a packet of data is sent from a probe device to host addresses and corresponding responses, or lack thereof, are received and/or recognized. In this context, a host is defined as any intelligent device attached to a network. Examples of host devices include, but are not limited to, routers, switches, gateways, computers, and the like. A host is identified by a specific local (or host) number that, together with its network number, forms the IP address of the host. Thus, a host address is associated with a host device reachable at that specific host address.

In one embodiment, in order to locate a host device associated with a host address, network routes are actively probed by iteratively bisecting the network range between the source address and the host address. First, a maximum TTL value to associate with the probe packets is selected. The actual probe packet being transmitted is set with a TTL value of one half the maximum value. For example, the maximum value, which in one embodiment is user configurable, may be selected as twenty. Thus, the actual probe packet would be set with a TTL value of ten, therefore bisecting the theoretical maximum network path to the host. If a Port Unreachable message is received from the host device, that means that the host device is located within a network distance represented by a TTL value of ten from the probe device 202. Hence, the location of the host is determinable based on the Port Unreachable message received from the host device.

If a Time Expired message is received, that means that the packet expired before reaching the host device, and thus it is located between a network distance represented by TTL values of ten and twenty. In this case, the network range represented by TTL values of ten and twenty is bisected by transmitting a packet with a TTL value of fifteen. Again, based on the type of response message received (Port Unreachable or Time Expired), the range in which the host device is located is determined. This range bisection process is continued until a Port Unreachable message is received and the host device is consequently located. Once the host is located, additional probe packets with appropriate TTL values are transmitted along the network route of interest in order to probe the intermediate hops on the network route between the probe device 202 and the host.

Returning to FIG. 3, at step 304, a network route map is built based on the operational characteristics that were gathered via the active probing of the network in step 302. For example, the data gathered by the probe can be processed, including combining with similar data from different probes and perspectives, analyzed, and compared with similar data from other available routes in order to build the route map. Since the route map is based on the network operational data, the resulting network routes are preferred for forwarding data packets from a routing device to improve end-to-end network performance. According to one embodiment, the step of building the network route map (step 304) may be additionally based on user-configurable telecommunication carrier preferences. At step 306, the network route map, or representations of the preferred routes described therein, are propagated to multiple network routing devices to provide the knowledge of network performance conditions to these routing devices. Thus, the routing devices can use the knowledge of the preferred routes to dynamically and intelligently select routes for forwarding data packets to a destination.

### Method for Routing Information on a Network

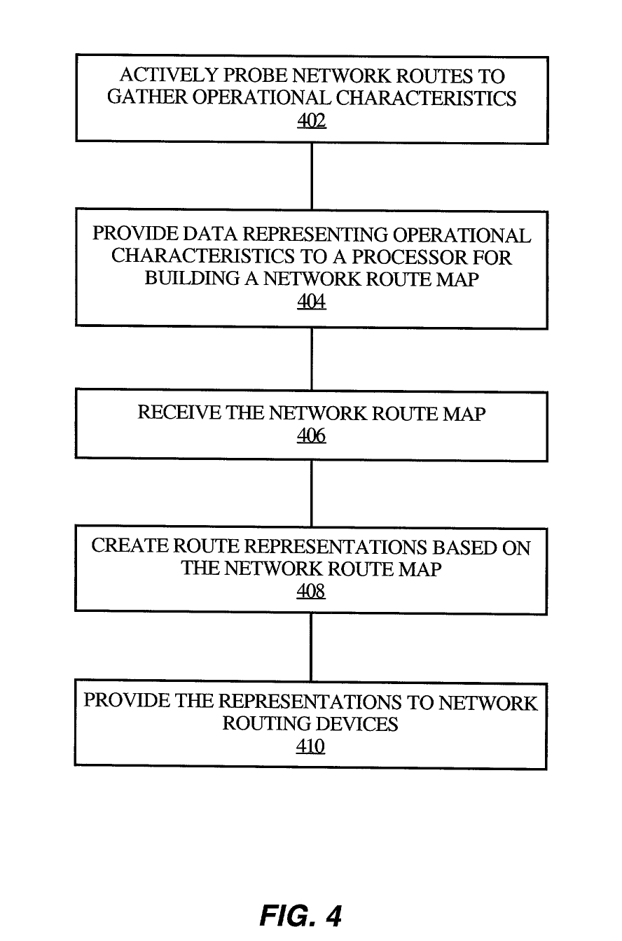

FIG. 4 is a flow diagram depicting a method for routing information on a network. This method is from the perspective of a probe device, such as probe device 202 (FIG. 2). At step 402, network routes are actively probed to gather network operational characteristics. Data representing the operational characteristics obtained via active probing is provided to a processing unit or logic, for example, route optimization engine 204, for building a map of performance-based preferred network routes, at step 404. At step 406, the network route map built by the processor is received. Reception of the route map may be pursuant to a request from the probe device or, alternatively, it may be passively received under the control of the processor. At step 408, representations of routes are created according to the route map. For example, specific routes may be derived from the map and may be converted to a format that routing devices, as well as gateway protocol servers, understand. Finally, the representations of the routes are provided to network routing devices, at step 410, thus sharing the network awareness gathered through actively probing the network and processing the gathered data into a global collection from numerous network perspectives.

### Method for Routing Information on a Network

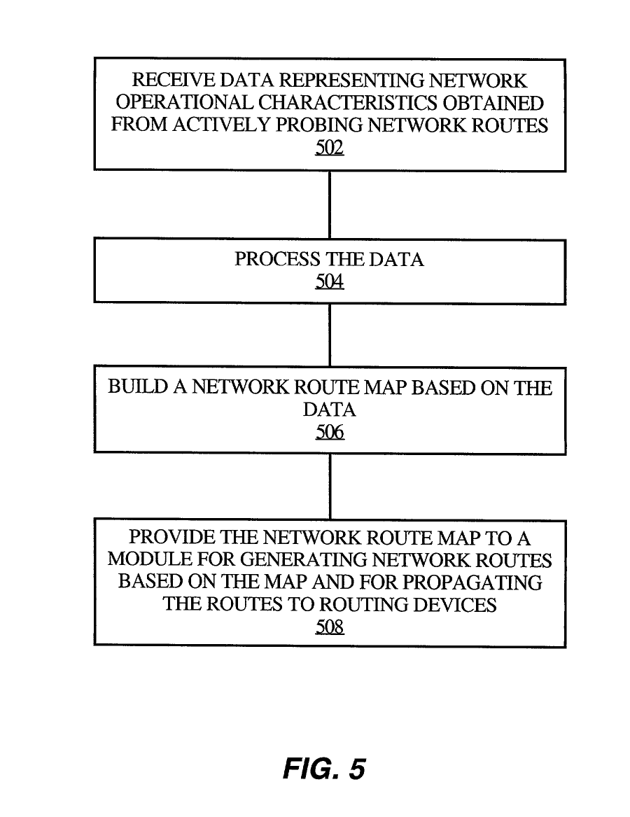

FIG. 5 is a flow diagram depicting a method for routing information on a network. This method is from the perspective of a processing unit, such as route optimization engine 204 (FIG. 2), or other logic that can perform the steps describing the method. At step 502, data representing network operational characteristics obtained from actively probing network routes is received. The data is processed, as described above primarily in reference to FIG. 2, at step 504. At step 506, a network route map is built based on the operational data. For example, as described in reference to FIG. 2, the data can be normalized, weighted, and summed to provide a mechanism for comparing alternate network routes via a common metric comprising the substance of multiple metrics. Finally, the network route map is provided to another module, for example, the probe device 202, for generating preferred, or optimized, network routes based on the map, which can in turn be propagated to multiple routing devices operating on the network.

Thus, methods and systems for building network route maps and for routing information on a network have been described.

### Hardware Overview

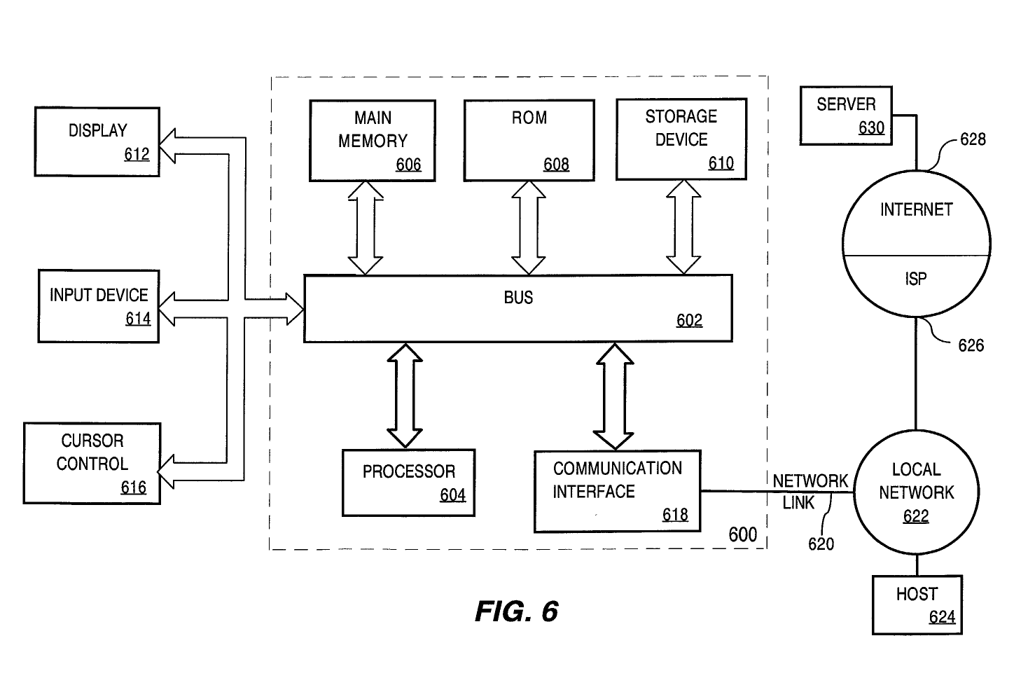

FIG. 6 is a block diagram that illustrates a computer system 600 upon which an embodiment of the invention may be implemented. Computer system 600 includes a bus 602 or other communication mechanism for communicating information, and a processor 604 coupled with bus 602 for processing information. Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Computer system 600 further includes a read only memory (ROM) 608 or other static storage device coupled to bus 602 for storing static information and instructions for processor 604. A storage device 610, such as a magnetic disk, optical disk, or magneto-optical disk, is provided and coupled to bus 602 for storing information and instructions.

Computer system 600 may be coupled via bus 602 to a display 612, such as a cathode ray tube (CRT) or a liquid crystal display (LCD), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

According to one embodiment of the invention, the techniques described herein are performed by computer system 600 in response to processor 604 executing one or more sequences of one or more instructions contained in main memory 606. Such instructions may be read into main memory 606 from another computer-readable medium, such as storage device 610. Execution of the sequences of instructions contained in main memory 606 causes processor 604 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 604 for execution. Such a medium may take many forms, including but not limited to, non-volatile media, volatile media, and transmission media. Non-volatile media includes, for example, optical, magnetic, or magneto-optical disks, such as storage device 610. Volatile media includes dynamic memory, such as main memory 606. Transmission media includes coaxial cables, copper wire and fiber optics, including the wires that comprise bus 602. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 604 for execution. For example, the instructions may initially be carried on a magnetic disk of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are exemplary forms of carrier waves transporting the information.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution. In this manner, computer system 600 may obtain application code in the form of a carrier wave.

As previously noted, embodiments can be implemented in software running on a system such as system 600, or could be implemented on a computing device developed for the implementation of embodiments. Such a computing device can include all of the elements of system 600, but is not so limited. For example, the probe device 202 (FIG. 2) may be implemented in a computing device that lacks a display such as display 612.

### Extensions and Alternatives

Alternative embodiments of the invention are described throughout the foregoing description, and in locations that best facilitate understanding the context of the embodiments. Furthermore, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

In addition, in this description certain process steps are set forth in a particular order, and alphabetic and alphanumeric labels may be used to identify certain steps. Unless specifically stated in the description, embodiments of the invention are not necessarily limited to any particular order of carrying out such steps. In particular, the labels are used merely for convenient identification of steps, and are not intended to specify or require a particular order of carrying out such steps.

What is claimed is:

1. A method for building a network route map, the method comprising the steps of:
actively probing a plurality of network routes to gather one or more network operational characteristics; and
building the network route map based on the operational characteristics that were gathered by actively probing.

2. The method of claim 1 wherein the step of building the network route map comprises the step of:
determining from the one or more operational characteristics a metric related to lost data packets for each of one or more hops between network devices on the plurality of network routes; and
building the network route map based, at least in part, on the metric.

3. The method of claim 2 wherein the step of determining the metric comprises the step of:
transmitting a data packet from a source to a host address, wherein the metric is determined based on absence of an acknowledgement in response to the data packet from one or more of the network devices.

4. The method of claim 1 wherein the step of building the network route map comprises the step of:
determining from the one or more operational characteristics a metric related to operational latency for each of one or more hops between network devices on the plurality of network routes; and
building the network route map based, at least in part, on the metric.

5. The method of claim 4 wherein the step of determining the metric comprises the step of:
transmitting a data packet from a source to a host address;
receiving a response to the data packet from each of the network devices between the source and a destination device at the host address and including the destination device; and
determining a time differential between the step of transmitting the data packet and the step of receiving each of the responses;
wherein the metric is determined based on the time differential.

6. The method of claim 5 wherein the step of transmitting the data packet from the source includes transmitting the data packet including a time to live value and wherein the step of receiving the response is according to a reaction to the data packet.

7. The method of claim 5 wherein the step of transmitting the data packet from the source includes transmitting the data packet to a port number that does not identify a port on which the destination device is listening, and wherein the step of receiving the response is according to a reaction to the data packet.

8. The method of claim 1 wherein the step of building the network route map comprises the step of:
determining from the one or more operational characteristics a metric related to a number of hops from a source to a host address for the plurality of network routes; and
building the network route map based, at least in part, on the metric.

9. The method of claim 8 wherein the step of determining the metric comprises the step of:
transmitting a data packet from a source to the host address;
receiving a response to the data packet from each of the network devices between the source and a destination device at the host address and including the destination device; and
determining a time differential between the step of transmitting the data packet and the step of receiving each of the responses;
wherein the metric is determined based on the time differential.

10. The method of claim 9 wherein the step of transmitting the data packet from the source includes transmitting the data packet including a time to live value and wherein the step of receiving the response is according to a reaction to the data packet.

11. The method of claim 9 wherein the step of transmitting the data packet from the source includes transmitting the data packet to a port number that does not identify a port on which the destination device is listening, and wherein the step of receiving the response is according to a reaction to the data packet.

12. The method claim 1 wherein the step of building the network route map comprises the step of:
determining from the one or more operational characteristics one or more metrics from a set consisting of network access point congestion, circuit congestion, and network route reliability; and
building the network route map based, at least in part, on the metrics.

13. The method of claim 12 wherein the step of determining one or more metrics comprises the step of:
transmitting a data packet from a source to a host address, wherein the metric is determined based on absence of an acknowledgement in response to the data packet from one or more network devices on the network route between the source and the host address and including a destination device at the host address.

14. The method claim 1 wherein the step of building the network route map comprises the step of:
determining from the one or more operational characteristics one or more metrics from a set consisting of throughput, historical reliability, maximum circuit capacity, and TCP/IP characteristics; and
building the network route map based, at least in part, on the metrics.

15. The method of claim 1 wherein the step of building the network route map comprises normalizing data representing the one or more of the operational characteristics among a plurality of network routes.

16. The method of claim 15 wherein the step of building the network route map comprises the step of:
applying weighting factors to each of the normalized data and summing the weighted normalized data to determine a route score for one or more of the plurality of network routes; and
wherein the network route map is based on the route scores.

17. The method of claim 1 further comprising the step of:
transmitting data representing the operational characteristics to a processor over a network;
wherein the step of building the network route map is performed by the processor.

18. The method of claim 17 further comprising the steps of:
receiving the network route map from the processor;
configuring a next-hop gateway according to the network route map;
creating a translated representation of the network route map; and
propagating the one or more translated representations of the network route map to one or more peer network devices over the network.

19. The method of claim 1 further comprising the step of:
propagating the network route map to one or more network routing devices.

20. The method of claim 1 further comprising the step of:
injecting the network route map into a network routing device on an ongoing basis.

21. The method of claim 20 wherein the step of injecting the network route map comprises the steps of:
configuring the routing device as a Border Gateway Protocol peer; and
advertising the network route map on an ongoing basis.

22. The method of claim 1 wherein the step of building the network route map comprises building the network route map for a particular routing device and from the perspective of the routing device.

23. The method of claim 1 wherein the step of building the network route map comprises building the network route map for a particular routing device and from the perspective of a network of which the routing device is constituent.

24. The method of claim 1
wherein the step of actively probing comprises:
actively y probing a plurality of network routes in which a particular routing device is constituent, whereby the routing device is actively probed from multiple perspectives; and
wherein the step of building the network route map comprises:
consolidating network operational characteristics from the multiple perspectives associated with the particular routing device.

25. The method of claim 1 wherein the step of actively probing is performed by a plurality of probe devices located at different locations on the network.

26. The method of claim 1 wherein the step of actively probing is performed according to a user specification of a network route for actively probing.

27. The method of claim 1 wherein the step of actively probing is performed according to a user specification of a network route to exclude from actively probing.

28. The method of claim 1 wherein the network route map is further based on a user specification of a telecommunication carrier preference and the step of building the network route map is according to the carrier preference.

29. A system comprising:
a probe device configured to actively probe for operational characteristics related to one or more network routes communicatively connected to a routing device; and
a route optimization engine communicatively connected to the probe device and configured to receive data representing the operational characteristics and to determine a network route map for network traffic through the routing device based on the data.

30. The system of claim 29 further comprising:
a server configured for propagating the network route map to one or more network routing devices.

31. The system of claim 30 further comprising:
a translator configured for translating the network route map from a first format associated with the route optimization engine to a second format associated with the server.

32. The system of claim 30 wherein the server is a Border Gateway Protocol server.

33. The system of claim 29 further comprising:
a load balancer configured for queuing the data representing the operational characteristics prior to reception by the route optimization engine.

34. The system of claim 33 wherein the load balancer is further configured for authenticating the probe device.

35. The system of claim 29 wherein the route optimization engine is further configured for responding to a request for a network route map wherein the route map is from a perspective associated with the routing device.

36. The system of claim 29 wherein the probe device is one of a plurality of probe devices and the route optimization engine is configured to receive data representing operational characteristics from the plurality of probe devices and to determine the network route map based on the data received from the plurality of probe devices.

37. The system of claim 36 wherein at least one of the plurality of probe devices and the route optimization engine are located on a single machine.

38. The system of claim 36 wherein at least one of the plurality of probe devices and the route optimization engine are located on separate machines.

39. The system of claim 29 wherein the routing device is capable of using Border Gateway Protocol to exchange routing information with other devices on a network.

40. The system of claim 29 wherein failure of the probe device does not prohibit the routing device from forwarding network traffic.

41. The system of claim 29 wherein the probe device can be configured to actively probe a specified network route for operational characteristics related to the specified network route.

42. The system of claim 29 wherein the probe device can be configured to exclude a specified network route from probing for operational characteristics related to the specified network route.

43. The system of claim 29 wherein the probe device can be installed external to the one or more network routing devices whereby the probe device is external to network data streams.

44. A method for routing information on a network, the method comprising the steps of:
actively probing a plurality of network routes to gather one or more network operational characteristics; and
providing data representing the operational characteristics to a processor for processing the data and for building a network route map based on the data for routing information on the network.

45. The method of claim 44, further comprising the steps of:
receiving the network route map;
creating a representation of each of one or more network routes based on the network route map; and
providing the representations to one or more network routing devices.

46. The method of claim 44 wherein a user can specify a network route to actively probe to gather one or more network operational characteristics and wherein the step of actively probing is performed according to the user specification.

47. The method of claim 44 wherein a user can specify a network route to exclude from actively probing to gather one or more network operational characteristics and wherein the step of actively probing is performed according to the user specification.

48. A method for routing information on a network, the method comprising the steps of:
receiving data representing network operational characteristics obtained from actively probing a plurality of network routes to gather the operational characteristics;
building a network route map based on the data; and
providing the network route map to a module for generating network routes based on the network route map for routing information on the network, the module including a server program for propagating the network routes to network routing devices.

49. An apparatus for building a network route map, the apparatus comprising:
means for actively probing a plurality of network routes to gather one or more network operational characteristics; and
means for building the network route map based on the operational characteristics that were gathered by the means for actively probing.

50. The apparatus of claim 49, further comprising:
means for propagating representations of network routes based on the network route map to network routing devices.

51. A computer-readable medium carrying one or more sequences of instructions for building a network route map, wherein execution of the one or more sequences of instructions by one or more processors causes the one or more processors to perform the steps of:
actively probing a plurality of network routes to gather one or more network operational characteristics; and
building the network route map based on the operational characteristics that were gathered by actively probing.

52. A computer-readable medium carrying one or more sequences of instructions for routing information on a network, wherein execution of the one or more sequences of instructions by one or more processors causes the one or more processors to perform the steps of:
actively probing a plurality of network routes to gather one or more network operational characteristics; and
providing data representing the operational characteristics to a processor for processing the data and for building a network route map based on the data for routing information of the network.

53. A computer-readable medium carrying one or more sequences of instructions for routing information on a network, wherein execution of the one or more sequences of instructions by one or more processors causes the one or more processors to perform the steps of:
receiving data representing network operational characteristics obtained from probing a plurality of network routes to gather the operational characteristics;
building a network route map based on the data; and
providing the network route map to a module for generating network routes based on the network route map for routing information on the network.

54. A method for locating a host device in a network, comprising the steps of:
specifying a maximum time to live value for a data packet probe;
transmitting from a source a first data packet probe with a time to live value equal or approximate to one half the maximum time to live value;
determining, based on a response to the first data packet probe, whether the host device is between the source and a network location represented by the one half maximum time to live value or between the network location represented by the one half maximum time to live value and a network location represented by the maximum time to live value; and
if determined that the host device is between the source and a network location represented by the one half maximum time to live value, then determining, based on the response to the first data packet probe, the network location of the host device.

55. The method of claim 54, wherein if determined that the host device is between the network location represented by the one half maximum time to live value and the network location represented by the maximum time to live value, the method further comprising the steps of:
(a) specifying a first minimum time to live value for a second data packet probe equal to the one half maximum time to live value;
(b) transmitting from the source the second data packet probe with a time to live value equal or approximate to one half the difference between the maximum time to live value and the first minimum time to live value;
(c) determining, based on a response to the second data packet probe, whether the host device is between a network location represented by the first minimum time to live value and the one half the difference or between the network location represented by the one half the difference and the network location represented by the maximum time to live value;
(d) if determined that the host device is between the network location represented by the first minimum time to live value and the one half the difference, then determining, based on the response to the second data packet probe, the network location of the host device; and
(e) if determined that the host device is between the network location represented by the one half the difference and a network location represented by the maximum time to live value, then iterating steps (a)-(d) by continuing to bisect the remaining distance between the network location represented by one half the difference and the network location represented by the maximum time to live value until the host device is located.
